(19) United States
(12) Patent Application Publication
(10) Pub. No.: US 2026/0069028 A1
(43) Pub. Date: Mar. 12, 2026

(54) SUCTION TOOTHBRUSH AND RELATED METHODS

(71) Applicant: RUTGERS, THE STATE UNIVERSITY OF NEW JERSEY, New Brunswick, NJ (US)

(72) Inventors: Maxine Strickland, Paramus, NJ (US); Glennon Simmons, Robbinsville, NJ (US); Dominic Peralta, San Mateo, CA (US)

(21) Appl. No.: 19/106,886

(22) PCT Filed: Aug. 31, 2023
(86) PCT No.: PCT/US2023/031604

§ 371 Date: Feb. 26, 2025

Related U.S. Application Data
(60) Provisional application No. 63/402,670, filed on Aug. 31, 2022.

(51) Int. Cl. A46B 15/00; A61C 17/22; A61C 17/34

(52) U.S. Cl. CPC A46B 15/0053; A61C 17/227; A61C 17/3481; A46B 2200/1066

(57) ABSTRACT

A suction toothbrush includes a handle defining an opening, a toothbrush head including internal channels, a seal with a distal end received within the toothbrush head and a proximal end coupled to the handle through the opening thereof, and a connector extending through the annular body of the seal. The connector includes a main body having a distal end disposed within the internal conduit of the toothbrush head and a proximal end extending into the handle through the top opening thereof, and a vibration motor housing offset from the proximal end of the main body. A waste reservoir for a suction toothbrush includes a lid, a basin defining a sump for waste material, and a gas-permeable membrane disposed between the lid and the basin that defines central inlet opening. A 3-D printing method for suction toothbrush heads.

### FIELD OF THE DISCLOSURE

The present disclosure generally relates to toothbrushes and, more particularly, to suction toothbrushes.

### BACKGROUND

Toothbrushes are an effective and common method for plaque removal. Management of fluids while brushing, however, can be a challenge for members of the young, convalescent, elderly, or disabled populations, who may have difficulty spitting and may tend to swallow or aspirate toothpaste and particulates removed from teeth during brushing. The remaining fluids after brushing contain microorganisms and bacteria that can result in dental caries, respiratory diseases, and pneumonia. While it has been well documented in the literature that powered toothbrushes offer enhanced brushing capability, the inventors are unaware of reliable, convenient mechanisms incorporated within or associated with, existing toothbrushes, whether manual or power-assisted, to collect toothpaste, saliva, water, blood, bacteria, food, plaque, or other debris from a person's mouth during brushing.

### SUMMARY

In accordance with a first aspect, a suction toothbrush is provided that includes a handle defining a top opening, and a toothbrush head including one or more inlet ports and an internal conduit fluidly coupled to the inlet port and open through a bottom surface of the toothbrush head. The suction toothbrush further includes a seal having an annular body with a distal end configured to be received within the internal conduit of the toothbrush head and an opposite, proximal end configured to couple to the handle through the top opening thereof. The suction toothbrush further includes a connector that is configured to extend through the annular body of the seal. The connector includes a main body having a distal end configured to be disposed within the internal conduit of the toothbrush head and an opposite, proximal end configured to extend into the handle through the top opening thereof, where the main body defines a passage to receive material from the internal conduit of the toothbrush head, and a vibration motor housing offset from the proximal end of the main body.

In some implementations, the annular body of the seal can include a flange disposed between the first and second end, where the flange is configured to be disposed between and sealingly engage a top surface of the handle extending around the top opening and the bottom surface of the toothbrush head. In further implementations, the top surface of the handle can include an annular groove and the flange can include a downwardly extending lip configured to be received within the annular groove.

In some implementations, the toothbrush head can include a head portion and a neck portion, where the inlet port is defined in the head portion and the internal conduit open through a bottom surface of the neck portion. In further implementations, the one or more fluid ports can include a distal port and opposing side ports; and/or the head portion can have a bristle recess and the suction toothbrush can include disposable bristles configured to couple within the bristle recess.

In some implementations, the suction toothbrush can include a suction assembly, where the suction assembly includes the toothbrush head, the connector; a water pump; a waste reservoir; and tubing connecting the connect to the water pump and the water pump to the waste reservoir. In further implementations, the tubing connecting the water pump to the waste reservoir can include a manifold.

In any of the above implementations, the suction toothbrush can include one or more of the following aspects: the suction toothbrush can include one or more o-rings disposed around the distal end of the main body of the connector to sealingly and frictionally engage the interior conduit of the toothbrush head; the seal and the connector can include interconnecting mating structures; the top opening of the handle can be a larger diameter than a portion of the first end of the annular body of the seal extending therethrough, providing the seal with freedom of movement for vibration of the toothbrush head; the first end of the annular body of the seal can include a radial rib configured to be received within a groove defined in an internal surface of the handle; the second end of the annular body of the seal and an end of the internal conduit of the toothbrush head can have complementary tapered configurations; the seal can include an orientation key and the toothbrush head can include an orientation slot configured to receive the orientation key of the seal therein to ensure the toothbrush head is oriented correctly relative to the seal; and/or the suction toothbrush can include a vibration motor configured to be received within the vibration motor housing of the connector, the vibration motor having a plurality of speed settings.

In accordance with a second aspect, a suction toothbrush is provided that includes a handle, a toothbrush head coupled to the handle; and a fluid pathway including one or more inlet ports defined in or adjacent to the toothbrush head, a water pump, and a waste reservoir. The waste reservoir includes a lid, a basin defining a sump for waste material, and a gas-permeable membrane disposed between the lid and the basin, where the membrane defines a central inlet opening. The waste reservoir is configured to releasably couple to the handle.

In some implementations, the lid can define one or more vent openings extending therethrough; and/or the lid includes an upwardly extending inlet stem. In further implementations, the suction toothbrush can include one or more o-rings disposed around the inlet stem to sealingly and frictionally engage the handle.

In some implementations, the lid can include a downwardly depending outlet funnel to direct material flow into the basin. In further implementations, the funnel can have a curved configuration and, optionally, the lid can define one or more vent openings extending therethrough aligned with the funnel.

In some implementations, the handle can include an outer housing having a bottom opening and a closure configured to be sealingly received within the outer housing through the bottom opening. The fluid pathway can include a port defined by the closure and the lid can include an upwardly extending inlet stem configured to be received within the port of the closure to fluidly connect the waste reservoir to other components of the fluid pathway. In further implementations, the port and the inlet stem can have complementary tapered configurations; the waste reservoir can be secured to the outer housing via a lock; and/or the lid can be secured to the basin via a lock.

In accordance with a third aspect, a method for manufacturing a suction toothbrush head having a head portion and a neck portion is provided that includes 3-D printing a toothbrush head with one or more inlet ports defined in the head portion and an internal conduit fluidly connected to the one or more inlet ports extending through the toothbrush head to open through a bottom surface of the neck portion; and printing a support structure extending between the toothbrush head and a work surface. 3-D printing the toothbrush head includes printing the toothbrush head in a downwardly angled orientation with the neck portion disposed above the head portion and a bristle area of the head portion facing upwardly so that no portion of the support structure contacts the bottom surface of the neck portion or the bristle area of the head portion.

In some implementations, 3-D printing the toothbrush head with the one or more inlet ports can include printing a toothbrush head with a distal inlet port and opposing side ports; 3-D printing the toothbrush head can include printing the toothbrush head with a surgical resin; the method can include setting a higher resolution for the bristle area of the tooth brush head and an end of the neck portion including the bottom surface thereof than other parts of the toothbrush head; and/or the method can include 3-D printing a plurality of the toothbrush heads in an array.

In some implementations, the method can include washing the toothbrush head in an alcohol solution after 3-D printing. In further implementations, washing the toothbrush head in the alcohol solution can include agitating the toothbrush head in the alcohol solution; and/or
washing the toothbrush head in the alcohol solution can include washing the toothbrush head three times in alcohol solutions. In further implementations, washing the toothbrush head three times can include washing the toothbrush head for a longer duration in a third wash than in first and second washes.

In some implementations, the method can include drying the toothbrush head and curing the toothbrush head. In further implementations, drying and curing the toothbrush head can include drying and curing the toothbrush head with the toothbrush head in the downwardly angled orientation; and/or cutting the support structure off of the toothbrush head. In further implementations, the method can include removing any remaining pieces of the support structure and surface roughness at connection points of the support structure to the toothbrush head; and/or washing the toothbrush head with soap and water to remove any remaining debris.

In some implementations, the method can include installing bristles onto the bristle area of the head portion. In further implementations, installing the bristles onto the bristle area of the head portion can include adhering the bristles to a surface of the bristle area; and/or the bristle area of the head portion can include a groove extending therearound and installing the bristles onto the bristle area of the head portion can include snap-fitting a base having the bristles coupled thereto into the groove.

### BRIEF DESCRIPTION OF THE DRAWINGS

The above needs are at least partially met through provision of the embodiments described in the following detailed description, particularly when studied in conjunction with the drawings, wherein:

FIG. 1 is a perspective view of a suction toothbrush in accordance with various implementations of the disclosure;

FIG. 2 is a is a cross-sectional view of the suction toothbrush of FIG. 1;

FIG. 3 is a perspective view of a toothbrush head for the suction toothbrush of FIG. 1;

FIG. 4 is a cross-sectional view of the toothbrush head of FIG. 3;

FIG. 5 is a cross-sectional view of a portion of the suction toothbrush of FIG. 1 showing a connection between a toothbrush head and a handle thereof;

FIG. 6 is a sectional, exploded view of the suction toothbrush of FIG. 1 showing a connection between a toothbrush head and a handle thereof;

FIG. 7 is a cross-sectional view of a portion of the suction toothbrush of FIG. 1 showing a waste reservoir and connection to a flow path thereof;

FIG. 8 is a diagrammatic view of an electronic assembly for the suction toothbrush of FIG. 1;

FIG. 9 is a perspective view of 3-D printed toothbrush heads having support structure connected thereto suitable for the suction toothbrush of FIG. 1;

FIG. 10 is a flowchart for a toothbrush head 3-D printing method; and

FIG. 11 is a graph showing data associated with some embodiments.

### DETAILED DESCRIPTION

A suction toothbrush and related methods are provided to suction fluids and debris resulting from brushing, including toothpaste, saliva, and other brushing by-products. The suction effectively removes liquids, foams, and other materials from the mouth of a user either during or after brushing to thereby prevent or minimize materials or liquids from being aspirated by the user to reduce the risk of infection by preventing harmful bacteria from getting into a user's lungs. The toothbrush is advantageously portable, with all the suction components integral with the toothbrush and/or contained with the housing or releasably coupled thereto.

The suction toothbrush can help to prevent the aspiration of fluids and debris containing microorganisms by safely evacuating the fluids during brushing. As such, respiratory diseases and various comorbidities can be avoided by reducing bacterial growth from excess fluids in the oral and pulmonary cavity.

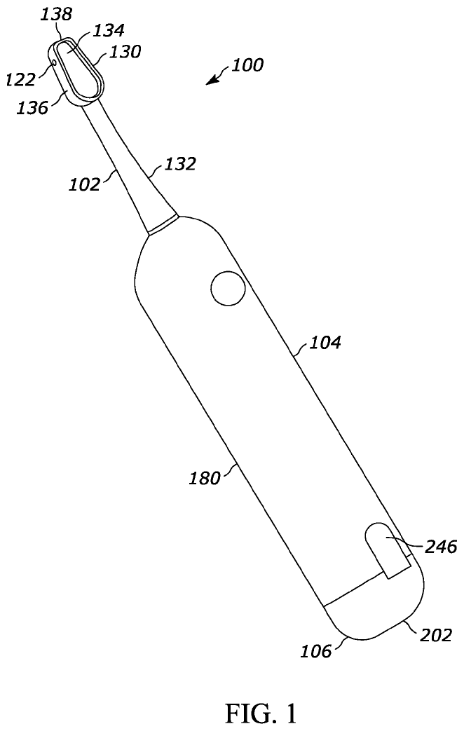

An example suction toothbrush 100 is shown in FIGS. 1-9. The toothbrush 100 includes a head 102, a handle 104, and a waste reservoir 106 selectively coupled together. The toothbrush 100 further includes a suction assembly 108 having the waste reservoir 106, a pump 110, and a flow path 112 running from the toothbrush head 102 to the waste reservoir 106, with the pump 110 configured to draw fluid and debris from around the toothbrush head 102, through the flow path 112, and into the waste reservoir 106. As described in more detail below, the flow path 112 can include internally defined channels 114, tubing 116, including tubes and manifolds 118, whether flexible or rigid, and couplings 120 to direct fluid and debris flow through the toothbrush 100 and to the waste reservoir 106.

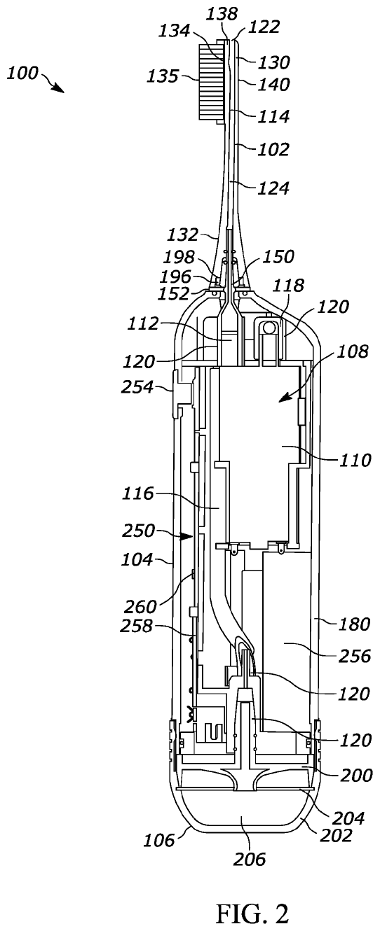

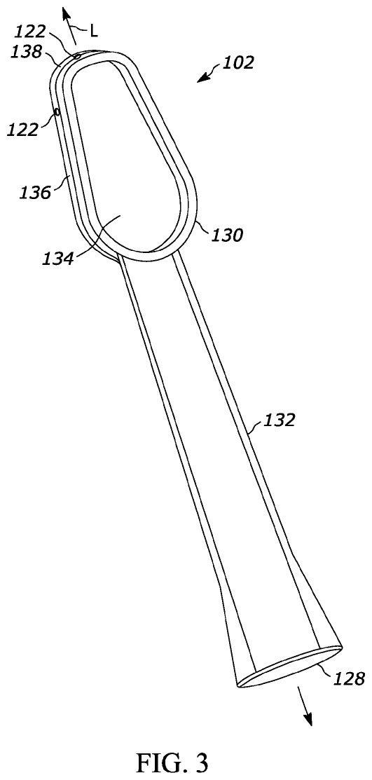

As shown in FIGS. 2 and 3, the toothbrush head 102 includes internal channels 114 in the form of one or more inlet ports 122 and an internal conduit 124 fluidly coupled together. The internal conduit 124 extends within the head 102 and runs from the inlet ports 122 to an opening 126 defined in a bottom surface 128 of the toothbrush head 102.

In one implementation, the toothbrush head 102 has an elongate configuration along a longitudinal axis L with a distal head portion 130 and a proximal neck portion 132. As shown, the head portion 130 has a forward facing bristle surface 134, side surfaces 136 and a distal end surface 138. The head portion 130 can have any suitable cross-sectional configuration, such as round, elongate, tapered, rectangular, track-shaped, etc. Depending on the configuration of the head portion 130, the side surfaces 132 and the end surfaces 138 can be substantially continuous or can have edges or curved surfaces therebetween. With this configuration, the internal conduit 124 extends from within or adjacent to the head portion 130 to the opening 126 defined in the bottom surface 128 of the neck portion 132. Moreover, bristles (not shown) and other scrubbing components extending outwardly from the bristle surface 134 of the toothbrush head 102 can have any suitable configuration. In one example, the bristle surface 134 can be recessed with a wall 135 extending therearound and disposable bristles can be configured to snap-fit within the recess.

The one or more inlet ports 122 of the toothbrush head 102 can have any suitable configuration. For example, the toothbrush head 102 can have a single inlet port 122 defined in the distal end surface 136 thereof or in one of the two side surfaces 138 thereof. Alternatively, the toothbrush head 102 can have two inlet ports 122, with one defined in each of the side surfaces 138. In another example, as shown, the toothbrush head 102 can have three inlet ports 122, with one defined in the distal end surface 136 and one defined in each of the side surfaces 138. Of course, additional inlet ports 122 can be defined in the end/side surfaces 136, 138 or surfaces of the toothbrush head 102, such as the bristle surface 134 or a back surface 140 opposite the bristle surface 134.

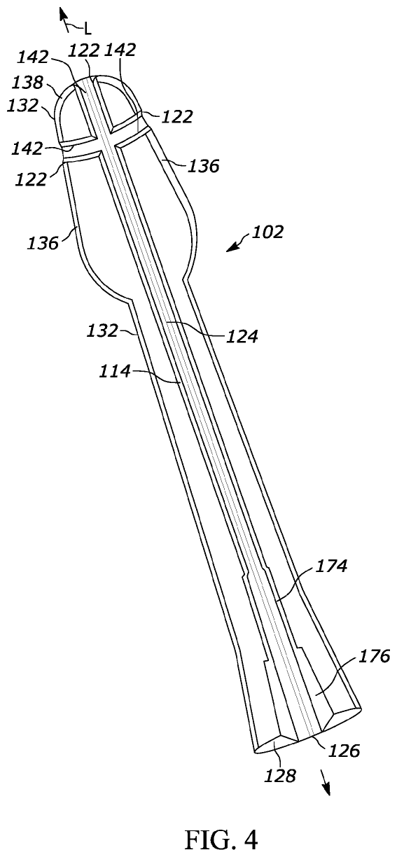

As shown in FIG. 4, the inlet ports 122 include internal passages 142 within the toothbrush head 102 to fluidly connect to the internal conduit 124. The passage 142 for an inlet port 122 in the distal end surface 138 can be substantially parallel or along the longitudinal axis L of the toothbrush head 102, while the passages 142 for inlet ports 122 in the side surfaces 136 can be transverse to the longitudinal axis L of the toothbrush head 102. For example, the passages 142 can be perpendicular, at an acute angle, and/or at an obtuse angle with respect to the longitudinal axis L.

As discussed above, the toothbrush head 102 and handle 104 are configured to releasably couple together. Pursuant to this, the toothbrush 100 includes a connector 150 and seal 152 that function to both physically couple the head 102 and handle 104 together, as well as to provide a coupling 120 for the flow path 112 between the head 102 and handle 104.

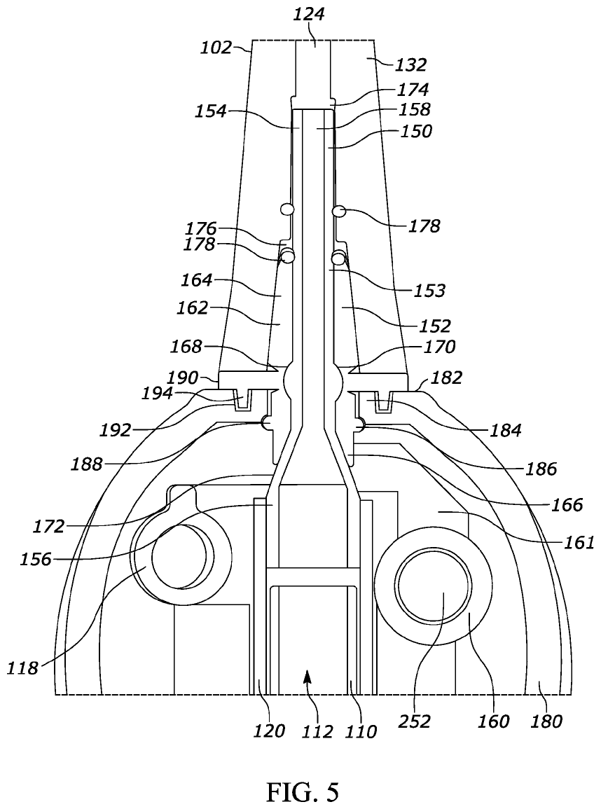

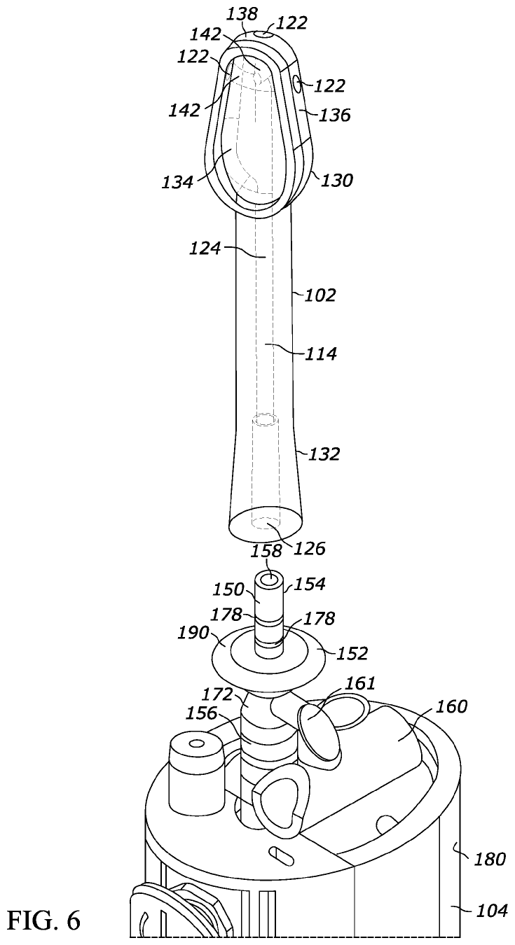

Details of the connector 150 and seal 152 are shown in FIGS. 5 and 6. The connector 150 includes a main body 152 having a distal end 154 configured to be disposed within the internal conduit 124 of the toothbrush head 102 and an opposite, proximal end 156 configured to extend into the handle 104. The main body 152 has a tubular configuration with a central passage 158 running longitudinally therethrough, such that flow through the internal conduit 124 of the toothbrush head 102 flows into the central passage 158 of the connector 150.

The connector 150 further includes a vibration motor housing 160 that is offset from and connected to the proximal end 156 of the main body 152. The vibration motor housing 160, as described in more detail below, is configured to receive a vibration motor to thereby vibrate the toothbrush head 102 via the connector 150 for brushing/scrubbing purposes. In order to fit within the housing 104 and allow the housing 104 to have a more compact configuration with a curved/tapering top, the vibration motor housing 160 can connect to the main body 152 via an arm 161. The arm 161 allows the vibration motor housing 160 to depend downwardly below the proximal end 156 of the main body 152.

The seal 152 has an annular body 162 with a first, distal end 164 configured to be received within the internal conduit 125 of the toothbrush head 102 and a second, proximal end 166 configured to couple to the handle 104. As shown, the annular body 162 of the seal 152 is sized to receive the main body 152 of the connector 150 therethough and is sized so that the distal and proximal ends 154, 156 extend outwardly therefrom. In one example, the seal 152 can be made from silicone rubber.

The connector 150 and seal 152 can have interconnecting mating structures 168,170 to frictionally or snap-fit hold the components together. For example, one of the connector 150 and seal 152 can include an annular protrusion 168 extending therearound and the other of the connector 150 and seal 152 can have a corresponding annular groove 170 configured to receive the protrusion 168 therein. The flexible nature of the seal 152 allows the body 162 to resiliently deform as the protrusion 168 is shifted therein until the protrusion 168 seats with the groove 170.

In one implementation, the proximal end 156 of the connector 150 can have a larger interior diameter than the distal end 154 and the main body 152 can have a tapering transition portion 172 between the distal and proximal ends 154, 156. With this configuration, the proximal end 166 of the seal 152 can seat on the tapering transition portion 172 of the connector 150 to provide an additional level of security in the correct placement of the seal 152 relative to the connector 150. For example, an interior surface of the seal proximal end 166 can have a complementary taper to seat on the tapering transition portion 172.

As shown in FIG. 4, the interior conduit 124 of the toothbrush head 102 can have a structure at an end thereof adjacent to the bottom surface 128 that is configured for coupling with connector 150 and seal 152. For example, the interior conduit 124 can have a stepped configuration with a first expanded diameter section 174 sized to frictionally receive the distal end 154 of the connector main body 152 therein and a second expanded diameter section 176 sized to frictionally receive the distal end 164 of the seal 152 therein. Advantageously, the transitional surface to the first expanded diameter section 174 can act as a stop surface for seating the connector 150 fully within the toothbrush head 102. Additionally, the second expanded diameter section 176 and the distal end 164 of the seal 152 can have complementary tapering configurations with expanding diameters approaching the bottom surface 128 of the toothbrush head 102. In some implementations, in order to ensure or aid with satisfactory sealing, one or more o-rings 178, such as two as shown or more, can be disposed around the distal end 154 of the connector main body 152 to sealingly and frictionally engage the interior conduit 124. For example, the o-rings 178 can be disposed around an intermediate portion of the distal end 154, directly adjacent to the seal 152, and so forth.

In the illustrated implementation, the handle 104 includes an outer housing 180 sized to receive components of the toothbrush 100 therein as described herein. The housing 180 includes a top surface 182 defining a top opening 184 therein to receive the proximal ends 156, 166 of the connector 150 and seal 152 therethrough. In order to releasably couple to the handle 104, the proximal end 166 of the seal 152 can include an annular rib 186 extending therearound that is configured to engage the handle 104 when the seal 152 is inserted through the top opening 184. The rib 186 can advantageously be disposed on the seal 152 at a location corresponding to a thickness of the handle housing 180, such that the rib 186 projects at least partially underneath the wall of the housing 180 around the top opening 184. If desired, an interior surface of the housing 180 can define a groove 188 extending around the opening 184 sized to receive the rib 186 therein.

In addition to engaging interior surfaces of the toothbrush head 102 and handle 104, the seal 152 can advantageously include a flange 190 that is configured to be sandwiched between the toothbrush head 102 and handle 104 when the two components are coupled together. As shown in FIG. 4, the flange 190 extends radially outwardly from an intermediate portion of the seal 152 between the distal and proximal ends 164, 166 thereof. When the toothbrush head 102 is fully coupled to connector 150 and seal 152, the flange 190 is disposed between and sealingly engages the top surface 182 of the handle 104 extending around the top opening 184 and the bottom surface 128 of the toothbrush head 102.

In one implementation, to provide additional sealing, the flange 190 and handle top surface 182 can include mating structures to provide a circuitous route for any potential fluid ingress into the housing interior. For example, the handle top surface 182 can define an annular groove 192 spaced radially outwardly from the top opening 184 and the flange 190 can include a downwardly extending lip 194 configured to be received within the annular groove 192 when the seal 152 is fully coupled to the handle housing 180.

As discussed above, the toothbrush head 102 is configured to be vibrated via the connection with the connector 150. Pursuant to this, the diameter of the top opening 184 in the handle housing 180 can be larger than a diameter of the portion of the seal proximal end 166 disposed within the top opening 184, allowing the seal proximal end 166 freedom of movement within the top opening 184 to thereby impart vibrations to the toothbrush head 102.

If desired, the toothbrush head 102 and seal 152 can be configured to fully seat together in only one orientation to ensure that the toothbrush head 102 is correctly oriented relative to the seal 152 and handle 104. To achieve this functionality, in one implementation, the toothbrush head 102 and seal 152 can include an interlocking key 196 and notch 198. For example, the seal 152 can include the key 196 extending upwardly from the flange 190 thereof and the interior conduit 124 of the toothbrush head 102 can include the notch 198 in an end thereof.

With the above configuration, the flow path 112 includes the one or more inlet ports 122 and the internal conduit 124 of the toothbrush head 102, the connector 150, the pump 110, the waste reservoir 106, and the tubing 116 connecting the connector 150 to the pump 110 and the pump 110 to the waste reservoir 106, including the manifold 118. The manifold 118 can advantageously be rigid to avoid kinking due to the flow path 112 routing within the handle 104. In one example, the tubing 116 can include silicone tubing.

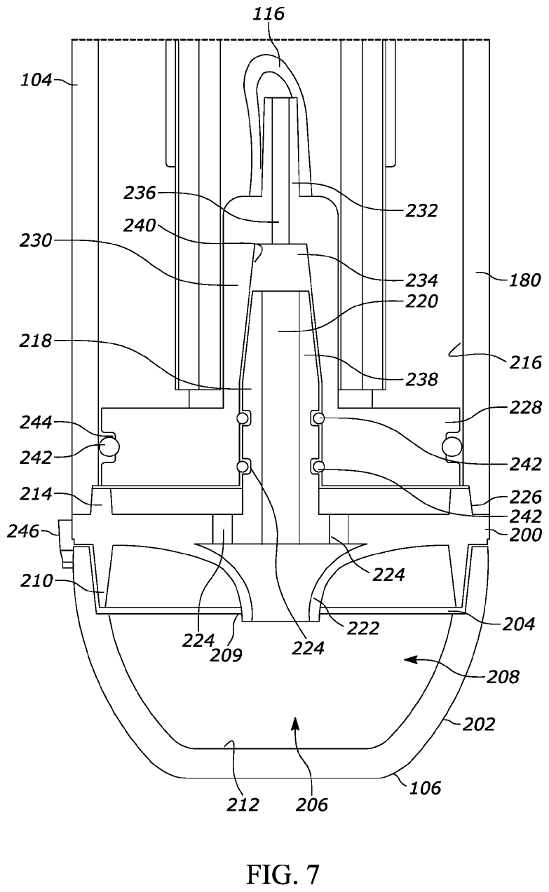

Details of the waste reservoir 106 are shown in FIG. 7. As shown, the waste reservoir 106 is configured to releasably couple to the handle 104. The waste reservoir 106 includes a lid 200, a basin 202, and a gas-permeable membrane 204. The basin 202 defines a sump 206 to receive the fluid and debris suctioned from around the toothbrush head 102. The membrane 204 extends across an interior 208 of the basin 202 and includes a central inlet opening 209, which allows the fluid and debris to be deposited into the basin 202. Advantageously, the membrane 204 allows gas to escape the basin 202, while retaining the fluid and debris within the sump 206. The membrane 204 can be coupled to the basin 202 or to the lid 200. The waste reservoir 106 is configured to releasably couple to the handle 104, allowing the waste reservoir 106 to be easily removed after use of the toothbrush 100 to empty the sump 206.

The lid 200 includes a downwardly extending lip 210 configured to be inserted into the basis 202 to frictionally engage an interior surface 212 of the basin 202 and allow the lid 200 to be press-fit onto the basin 202. The lid 200 further includes an upwardly extending lip 214 configured to be inserted into the handle housing 180 to frictionally engage an interior surface 216 of the housing 180 and allow the lid 200 to be press-fit onto the housing 180.

To fluidly couple the waste reservoir 106 to the rest of the flow path 112, the lid 200 includes an upwardly extending inlet stem 218 having a central passage 220 and a downwardly depending outlet funnel 222. As shown, the funnel 22 can have a curved configuration, such as concavely curved as shown. In the illustrated form, the membrane 204 is coupled to the downwardly extending lip 210 and extends across the basin 202 to engage the funnel 22. The inlet opening 210 of the membrane 204 can be sized to engage the funnel 22 on all sides to prevent fluid leakage thereby.

The lid 200 can further include one or more vents 224 extending therethrough to allow the passage gas therethrough. In the illustrated form, the base of the funnel 222 can have a larger perimeter than the inlet stem 218. In this form, the vents 224 can be disposed through the lid 202 aligned with the funnel 222 and spaced outwardly from the inlet stem 218.

As shown, the handle housing 180 defines a bottom opening 226 and the toothbrush 100 further includes a closure 228 configured to be sealingly received within the housing 180 through the bottom opening 226. The closure 228 includes a port 230 of the flow path 112 configured to be disposed between the tubing 116 within the handle housing 180 and the inlet stem 218 of the lid 200. Pursuant to this, in one form, the port 230 includes an upper stem 232 configured to be inserted into the tubing 116 and a lower cavity 234 sized to receive the inlet stem 218 therein. As shown, a passage 236 of the stem 232 is fluidly connected to the cavity 234, such that the tubing 116 fluidly connects to the inlet stem 218 of the lid 200 to thereby deposit fluid and debris into the waste reservoir 106 via the funnel 222.

In some examples, a distal end 238 of the inlet stem 218 and an interior surface 240 of the cavity 234 can have complementary tapered configurations. Further, the closure 228 and the inlet stem 218 can have one or more o-rings 242 extending therearound to sealingly and frictionally engage the interior surface 216 of the housing 180 and the interior surface 240 of the cavity 234, respectively. As shown, the o-rings 242 can be disposed within annular grooves 244 defined in exterior surfaces of the closure 228 and inlet stem 218.

Utilizing press-fit configurations between the lid 200 and basin 202 and between the lid 200 and housing 180 is satisfactory for many uses, however, in some instances, it may be desirable to have more secure couplings. Pursuant to this, the waste reservoir 106 can be secured to the housing 180 and/or the lid 200 can be secured to the basin 200 via a lock 246, such as a latch, screw threading, snap-fit structure, etc.

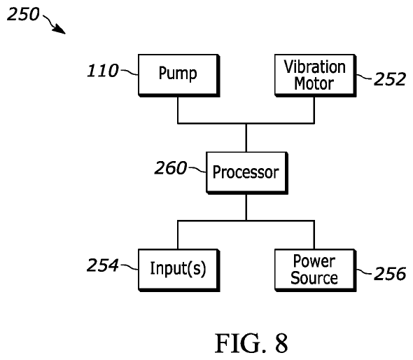

As shown in FIG. 8, an electronic assembly 250 for the toothbrush 100 includes the pump 110, a vibration motor 252 configured to be received within the vibration motor housing 160, one or more inputs 254, such as switches, buttons, etc., a power source 256, and a processor 260 electrically connected by suitable connections, such as a circuit board, traces, wires, leads, etc. In one implementation, the vibration motor 252 can have a plurality of speed settings that can be toggled through via selection of one the inputs 254.

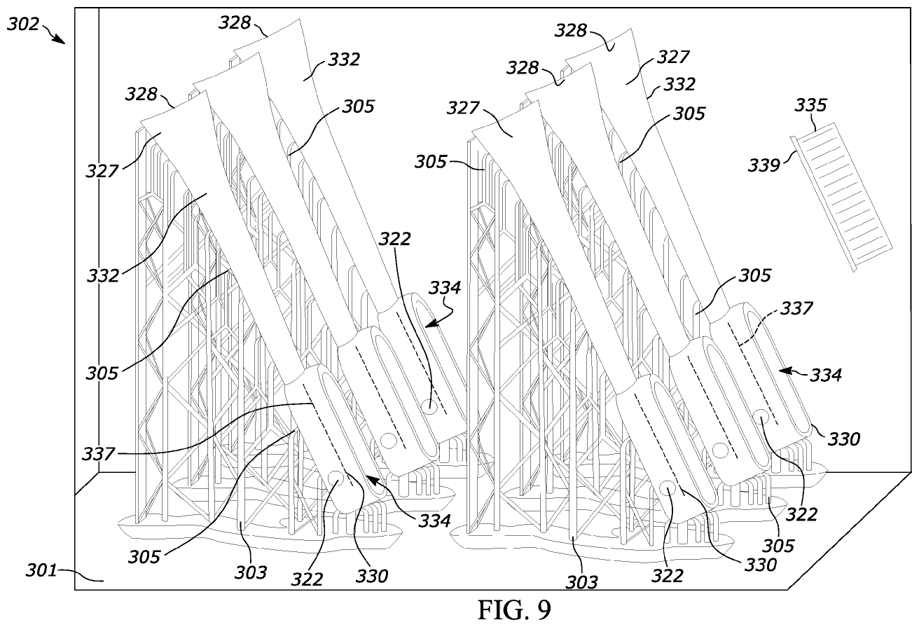

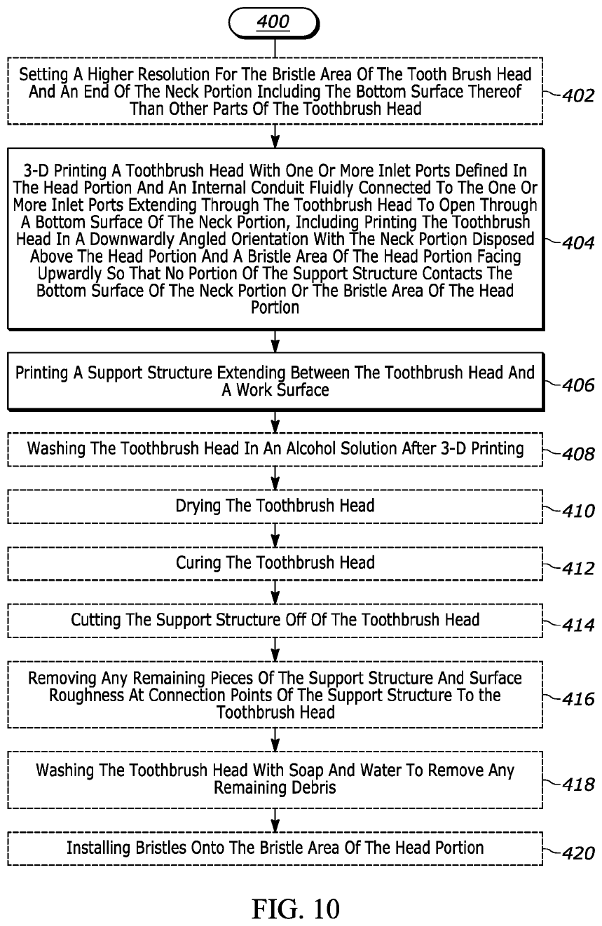

In some implementations, one or more toothbrush heads 302, identical to the toothbrush head 102 described above and suitable for the toothbrush 100, can be manufacturing using a 3-D printing method 400 as shown in FIGS. 9 and 10. The toothbrush head 302 has a head portion 330 and a neck portion 332.

The method 400 includes, entering details for the 3-D printing process, including loading a file containing a model of the toothbrush heads 302 and support structure 303 therefor. In a first step 402, the details can include setting a higher resolution for a bristle area 334 of the toothbrush head portion 330 and an end 327 of the neck portion 332 including a bottom surface 328 thereof than other parts of the toothbrush head portion 330.

Thereafter, in a second step 404, the method 400 includes 3-D printing the toothbrush head 302 with one or more inlet ports 322 defined in the head portion 330 and an internal conduit (not shown) fluidly connected to the one or more inlet ports 322 extending through the toothbrush head portion 330 to open through the bottom surface 328 of the neck portion 332. In a third step 406, the method 400 includes printing the support structure 303, which extends between the toothbrush head portion 330 and a work surface 301. It will be understood that while steps 404 and 406 are described separately, in the 3-D printing process, the creation of the toothbrush head 302 and the support structure 303 occurs simultaneously.

In step 404, 3-D printing the toothbrush head 302 can include printing the toothbrush head 302 in a downwardly angled orientation with the neck portion 332 disposed above the head portion 330 and the bristle area 334 of the head portion 330 facing upwardly so that no portion of the support structure 301 contacts the bottom surface 328 of the neck portion 332 or the bristle area 334 of the head portion 330.

In step 404, 3-D printing the toothbrush head 302 with the one or more inlet ports 322 can also include printing the toothbrush head 302 with a distal inlet port 322 and opposing side ports 322; printing the toothbrush head 302 with a resin, such as a surgical resin; and/or 3-D printing a plurality of the toothbrush heads 302 in an array, such as 4, 6, 8, or more.

The method 400 can further include, in a fourth step 408, washing the toothbrush head 302 in an alcohol solution after 3-D printing. For example, step 408 can include washing agitating the toothbrush head 302 in the alcohol solution; washing the toothbrush head 302 three times in alcohol solutions. In one example, washing the toothbrush head 302 three times can include washing the toothbrush head 302 for a longer duration in a third wash than in first and second washes.

In fifth and sixth steps 410, 412, the method includes drying the toothbrush head 302 and curing the toothbrush head 302. For example, drying and curing the toothbrush head 302 can include drying and curing the toothbrush head 302 with the toothbrush head 302 in the downwardly angled orientation.

In a seventh step 414, the method 400 can include cutting the support structure 303 off of the toothbrush head 302. Thereafter, in an eighth step 416, the method 400 can include removing any remaining pieces of the support structure 303 and surface roughness at connection points 305 of the support structure 303 to the toothbrush head 302 and, in a ninth step 418, washing the toothbrush head 302 with soap and water to remove any remaining debris.

In a tenth step 420, the method 400 can include installing bristles 335 onto the bristle area 334 of the head portion 330. For example, installing the bristles 335 onto the bristle area 334 of the head portion 330 can include adhering the bristles 335 to a surface of the bristle area 334. In another example, the bristle area 334 of the head portion 330 can include a groove 337 extending therearound, and installing the bristles 335 onto the bristle area 334 of the head portion 330 can include snap-fitting a base 339 having the bristles 335 coupled thereto into the groove 337.

### EXAMPLES

### Overview

Microbiological evaluation-Powered toothbrush with evacuation-Disinfection of suction toothbrush vacuum lines. Streptococcus mutans was grown to mid-exponential OD600 growth and CFU/ml was determined at the start of the experiments. The cultures were aspirated through control and experimental suction toothbrushes. The control suction toothbrush was disinfected with water. The experimental toothbrush was disinfected with water and Listerine®. Colony counts from each final wash was determined.

### Details

Streptococcus mutans strain 25175 was revived from storage in −80° C. on Mitis-Salivarius agar plates. 5 ml of Brain Heart Infusion (BHI) in a 15 ml sterile centrifuge tube was inoculated and incubated overnight under agitation at 37° C. and 250 RPM. The following day 20 ml 1:10 subcultures were made of BHI. Initial optical density was recorded, and the tubes were incubated at 37° C. under agitation at 250 RPM until an optical density reading of between 0.4 and 0.7 was achieved.

Two suction toothbrushes configured as described herein were used in the experiment—one as a control suction toothbrush and the other as an experimental suction toothbrush. For each process, 1 ml of exponentially growing Streptococcus mutans strain #25175 bacterial culture in Brain Heart Infusion (BHI) medium was suctioned into the internal mechanism of the respective suction toothbrush. For the control suction toothbrush, three consecutive washes of 10 ml of sterile water were passed through the internal suction mechanism. For the experimental suction toothbrush, washes consisted of a first wash of 10 ml of sterile water, a second wash of 10 ml of Listerine® Cool Mint, and a third wash of 10 ml sterile water. The final washes for both the experimental and control suction toothbrushes were collected into sterile petri dishes for subsequent serial dilutions and plating. 100 μl of undiluted final washes and 10-fold serial dilutions were plated onto sterile Mitis-Salivarius agar plates. The bacterial subculture used in the experiment was also subjected to 10-fold serial dilutions and 10 μl were plated onto sterile Mitis-Salivarius agar plates to determine starting CFUs/ml and verify viability of cells used in the experiment. Additionally, the remaining collected samples were centrifuged at 3700 RPMs for 15 minutes. The supernatants were removed with laboratory vacuum suction leaving 100 μl of sample to plate. This was then plated onto sterile Mitis-Salivarius agar plates. All plates were left to grow in an incubator at 37° C. for 48 hours before CFU/ml counts of each plate were completed.

### Results

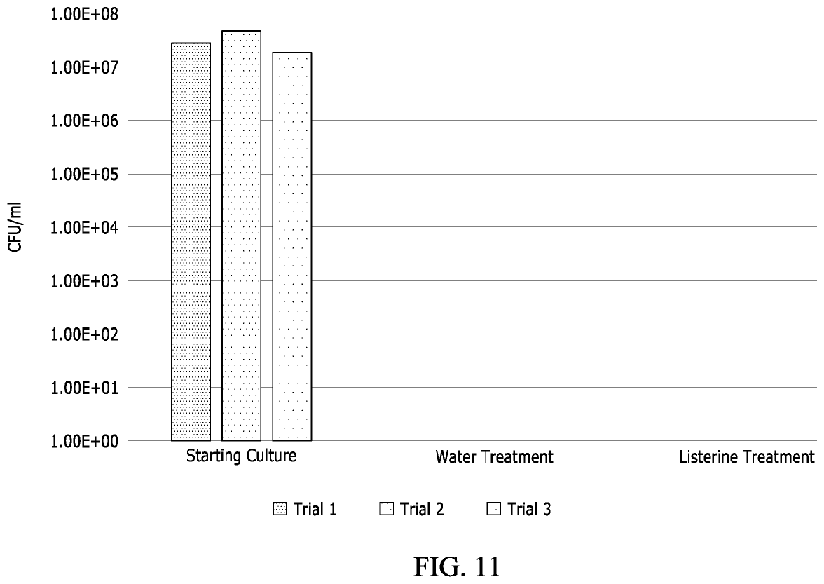

As shown in FIG. 11, three separate (independent biological) replicates of the experiment resulted with 30, 47, and 18 CFUs counted on the plate containing the 6th serial dilution of the bacterial cell culture, which indicated an average concentration of bacteria of 3.2×10⁸ cells/ml in the original sample used. No growth was visible on any plates containing samples from either the experimental or the control after 48 hours of incubation.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein

It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples within departing from the scope of the claims.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. A suction toothbrush comprising:
a handle defining a top opening;
a toothbrush head including one or more inlet ports and an internal conduit fluidly coupled to the inlet port, the internal conduit open through a bottom surface of the toothbrush head; and
a connector comprising:
a main body having a distal end configured to be disposed within the internal conduit of the toothbrush head and an opposite, proximal end configured to extend into the handle through the top opening thereof, the main body defining a passage to receive material from the internal conduit of the toothbrush head; and
a vibration motor housing offset from the proximal end of the main body.

2. The suction toothbrush of claim 1, further comprising one or more o-rings disposed around the distal end of the main body of the connector to sealingly and frictionally engage the interior conduit of the toothbrush head.

3. The suction toothbrush of claim 44, wherein the seal and the connector comprise interconnecting mating structures.

4. The suction toothbrush of claim 44, wherein the annular body of the seal further comprises a flange disposed between the first and second end, the flange configured to be disposed between and sealingly engage a top surface of the handle extending around the top opening and the bottom surface of the toothbrush head.

5. (canceled)

6. The suction toothbrush of claim 1, wherein the top opening of the handle has a larger diameter than a portion of the first end of the annular body of the seal extending therethrough, providing the seal with freedom of movement for vibration of the toothbrush head.

7.-9. (canceled)

10. The suction toothbrush of claim 1, wherein the toothbrush head comprises a head portion and a neck portion, the inlet port defined in the head portion and the internal conduit open through a bottom surface of the neck portion.

11. The suction toothbrush of claim 10, wherein the one or more fluid ports include a distal port and opposing side ports.

12. The suction toothbrush of claim 10, wherein the head portion comprises a bristle recess; and further comprising disposable bristles configured to couple within the bristle recess.

13. The suction toothbrush of claim 1, further comprising a suction assembly, the suction assembly comprising:
the toothbrush head;
the connector;
a water pump;
a waste reservoir; and
tubing connecting the connect to the water pump and the water pump to the waste reservoir.

14. The suction toothbrush of claim 13, wherein the tubing connecting the water pump to the waste reservoir includes a manifold.

15. The suction toothbrush of claim 1, further comprising a vibration motor configured to be received within the vibration motor housing of the connector, the vibration motor having a plurality of speed settings.

16. A suction toothbrush comprising:
a handle;
a toothbrush head coupled to the handle;
a fluid pathway including one or more inlet ports defined in or adjacent to the toothbrush head, a water pump, and a waste reservoir, the waste reservoir comprising:
a lid; and
a basin defining a sump for waste material; and
wherein the waste reservoir is configured to releasably couple to the handle.

17. The suction toothbrush of claim 16, wherein the waste reservoir defines one or more vent openings extending therethrough.

18. The suction toothbrush of claim 16, wherein the lid waste reservoir includes an upwardly extending inlet stem.

19. The suction toothbrush of claim 18, further comprising one or more o-rings disposed around the inlet stem to sealingly and frictionally engage the handle.

20. The suction toothbrush of claim 16, wherein the lid includes a downwardly depending outlet funnel to direct material flow into the basin.

21.-22. (canceled)

23. The suction toothbrush of claim 16, wherein the handle comprises an outer housing having a bottom opening and a closure configured to be sealingly received within the outer housing through the bottom opening; the fluid pathway includes a port defined by the closure; and the waste reservoir includes an upwardly extending inlet stem configured to be received within the port of the closure to fluidly connect the waste reservoir to other components of the fluid pathway.

24. (canceled)

25. The suction toothbrush of claim 23, wherein the waste reservoir is secured to the outer housing via a locking mechanism.

26.-42. (canceled)

43. The suction toothbrush of claim 1, wherein the toothbrush comprises a structure adjacent to the bottom surface configured for coupling with the connector.

44. The suction toothbrush of claim 1, further comprising a seal comprising an annular body with a distal end configured to be received within the internal conduit of the toothbrush head and an opposite, proximal end configured to couple to the handle through the top opening thereof.
